(19) United States
(12) Patent Application Publication
(10) Pub. No.: US 2026/0367615 A1
(43) Pub. Date: Nov. 19, 2026

(54) CONTROLLING OPERATION OF AN INDUSTRIAL PROCESS

(71) Applicant: Schlumberger Technology Corporation, Sugar Land, TX (US)

(72) Inventor: Mahdad Eghbalian, Calgary (CA)

(21) Appl. No.: 19/207,436

(22) Filed: May 14, 2025

(51) Int. Cl. G05B 19/418

(52) U.S. Cl. CPC G05B 19/41885; G05B 19/41865

(57) ABSTRACT

An industrial process control system may identify an operating status of industrial equipment that perform the industrial process. An industrial process control system may update a plurality of function parameters of an objective function with the operating status of the industrial equipment. An industrial process control system may apply a smoothing model to the objective function, the smoothing model adjusting the plurality of function parameters based on an impact of the plurality of function parameters on the output of the objective function. An industrial process control system may identify, using the smoothed objective function, a smoothed solution based on the plurality of function parameters. An industrial process control system may generate, using the smoothed solution, one or more changes to at least one of a plurality of operating parameters.

### BACKGROUND OF THE DISCLOSURE

Industrial systems include multiple units of equipment, receive multiple inputs, and generate multiple outputs. Changes to the system may have multiple impacts, which may be difficult to predict, and result in inefficient operation of the industrial system. Operators generally attempt to improve the efficiency of such industrial systems by optimizing an objective function that incorporates the desired attributes of the industrial system deemed important for its efficiency. The objective function may be a highly complex function that may require iterative solutions to be optimized. However, such iterative solutions may be imperfect, arriving at local solution and/or consume large amounts of processing resources and/or time.

### SUMMARY

In some aspects, the techniques described herein relate to a method for management of an industrial process. An industrial process control system identifies an operating status of industrial equipment that perform the industrial process. The industrial process control system updates a plurality of function parameters of an objective function with the operating status of the industrial equipment. The plurality of function parameters are adjustable to change an output of the objective function. The industrial process control system applies a smoothing model to the objective function. The smoothing model adjusts the plurality of function parameters based on an impact of the plurality of function parameters on the output of the objective function. The smoothing model generates a smoothed objective function. The industrial process control system identifies, using the smoothed objective function, a smoothed solution based on the plurality of function parameters. The industrial process control system generates, using the smoothed solution, one or more changes to at least one of a plurality of operating parameters.

In some aspects, the techniques described herein relate to a method for management of an industrial process. An industrial process control system applies a smoothing model to an objective function. The objective function includes a plurality of function parameters associated with operating parameters of an industrial process. The smoothing model generates a smoothed objective function. The industrial process control system generates a map of the objective function to the smoothed objective function. The industrial process control system optimizes the smoothed objective function resulting in a smoothed solution. The industrial process control system, using the map, generates a recommendation for at least one change to the operating parameters of the industrial process from the smoothed solution.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a schematic representation of an industrial process control system, according to at least one embodiment of the present disclosure.

FIG. 2 is a schematic representation of an industrial facility control system, according to at least one embodiment of the present disclosure.

FIG. 3 is a representation of a flow diagram of an industrial facility control system, according to at least one embodiment of the present disclosure.

FIG. 4 is a representation of a flow diagram of a production facility control system, according to at least one embodiment of the present disclosure.

FIGS. 5-1 and 5-2 are representations of a graphical illustration of an objective function, according to at least one embodiment of the present disclosure.

FIG. 6 is a flowchart of a method for management of an industrial process, according to at least one embodiment of the present disclosure.

FIG. 7 is a flowchart of a method for management of an industrial process, according to at least one embodiment of the present disclosure.

FIG. 8 illustrates certain components that may be included within a computer system.

### DETAILED DESCRIPTION

This disclosure generally relates to devices, systems, and methods for controlling an industrial process. Industrial processes, such as oil and gas production and processing, manufacturing activities, fluid processing, compressing, and other industrial processes, are often complex, with large numbers of equipment. The processes often include multiple systems or lines, including primary, secondary, waste, and other systems or lines. The intricate interplay between components of an industrial system may make it difficult to find the most efficient operating conditions. Further, the operation of an industrial process may be improved or made more efficient for different factors, such as power consumption, operating cost, carbon dioxide emissions, throughput, equipment wear and tear, maintenance, personnel hours and/or staffing, and so forth. In some situations, an efficient solution for one factor may be inefficient for another factor.

The industrial process may be modeled. For example, the operating efficiency of the industrial process may be described using an objective function. The objective function may include one or more function parameters that may be based on and/or include an operating state of the industrial process. For example, the operating status of the industrial equipment may be measured, and the operating status input into the objective function. The output of the objective function may be used to identify the operating efficiency of the industrial process. For example, using the factors identified above, the output of the objective function may include one or more of power consumption, operating cost, carbon dioxide emissions, material throughput, material consumption, equipment wear and tear, maintenance recommendations, personnel hours, staffing recommendations, and so forth.

The function parameters of the objective function may be adjusted, and the output analyzed. In some situations, the function parameters may be adjusted to maximize or minimize a particular factor of the objective function. For example, the function parameters may be adjusted, and the objective function applied to the adjusted function parameters. The adjusted output of the objective function may be compared to the output based on the operating status. This process may be iterated or repeated to minimize or maximize a particular factor of the objective function. The convergence solution of the objective function may be when additional iterative or step-wise changes to the function parameters reduce the efficiency (e.g., the maximization or minimization) of the objective function.

In some situations, adjustments to the function parameters may have different impacts on the output of the objective function. For example, changes to certain equipment, processes, or measured values may result in different changes to the output of the objective function. In some situations, change to a first function parameter may have a larger impact on the output of the objective function than a commensurate change (e.g., a change of the same magnitude and/or percent) to a second function parameter. This may increase the difficulty and/or complexity of finding a solution or convergence of the objective function for a particular output factor. As the number of function parameters of an objective function increase, the complexity of the objective function may increase, resulting in additional processing power and/or time used to identify the solution to the objective function. This disparate levels of impact on the objective function may be referred to as the skew of the objective function. As the skew of the objective function increases, the processing resources and/or time used to identify the solution to the objective function may increase.

Conventional mechanisms to reduce the skew of the objective function may include scaling the objective function such that each of the function parameters are normalized to the same value. But such simplistic scaling methods fail to account for the different impact of the various function parameters on the output of the objective function. For example, two function parameters may have values that differ by one or more orders of magnitude, but changes to the function parameters may have the same impact on the objective function, or an equal impact on the objective function. Scaling the objective function based on the value of the function parameters may not significantly reduce the processing resources and/or time used to identify a solution. In some situations, scaling the objective function may be unreliable, resulting in bespoke and/or customized solutions to different objective functions for different industrial processes. Thus, there is a need for a reliable, widely applicable, and unbiased mechanism to optimize objective functions.

In accordance with at least one embodiment of the present disclosure, a smoothing model may be applied to the objective function to smooth the objective function. For example, the smoothing model may adjust the function parameters of the objective function based on some measurement of the skew of the objective function. In some embodiments, the smoothing model may be a Hessian-supported smoothing model. For example, the Hessian-supported smoothing model may identify the eigenvalues and eigenvectors of the function parameters of the objective function. The smoothing model may adjust the plurality of function parameters based on the eigenvalues and eigenvectors. The resulting mapped objective function may reduce or eliminate the skew of the objective function. In some embodiments, the mapped objective function may be close to or include a hypersphere.

The mapped objective function may be optimized, or may generate a solution for a particular factor resulting in a minimization or a maximization of that particular factor. Because the mapped objective function has reduced or no skew, the solution to the mapped objective function may be found using fewer iterative steps than using conventional methods. For example, the mapped objective function may be optimized with fewer than 50 % of the iterative steps than a conventional solution. The solution to the mapped objective function may be converted to an objective function solution, or a demapped solution.

An analysis of the convergence solution of the objective function (including the objective function solution optimized from the mapped objective function) for a particular industrial process may identify one or more changes to one or more operating parameters of the industrial equipment. For example, one or more of the function parameters of the objective function may be associated with industrial equipment operating settings. The function parameters of the objective function that resulted in the converged solution may be analyzed to identify the equipment operating settings. The operating settings of the industrial equipment may be changed to match the operating settings from the solution to the objective function, thereby increasing the operating efficiency of the industrial process. In this manner, identifying, applying the smoothing model to the objective function, and optimizing the mapped objective function may facilitate efficient management of the industrial process in real time, or within sufficient time to make changes to the operating parameters of the industrial process.

As illustrated by the foregoing discussion, the present disclosure utilizes a variety of terms to describe features and advantages of the production facility control system. Additional detail is now provided regarding the meaning of such terms. For example, as used herein, the term “operating state” refers to the condition of a production facility or other facility or set of equipment used in an industrial process. For example, the operating state of the industrial process may include a representation of a status of various units of equipment. The status of the units of equipment may include operating, not operating, operating inputs, operating outputs, motor speed, motor energy consumption, pressure, temperature, volumetric flow rate, mass flow rate, fuel consumption, any other status, and combinations thereof, including inclusions or exclusions of any of the foregoing. In some embodiments, the operating state includes the status of a single unit of equipment. In some embodiments, the operating state includes the individual status of multiple units of equipment. In some embodiments, the operating state includes a combination of statuses of units of equipment, including summations or other functions of multiple units of equipment. In some embodiments, the operating state may include the overall facility status, including overall facility inputs, overall facility outputs, facility input composition, facility output composition, total energy consumption, any other overall facility status, and combinations thereof, including inclusions and exclusions of any of the foregoing. The operating state may be determined in any manner. For example, the operating state may be determined using sensed conditions using various sensors located at various positions around the industrial facility. In some examples, the operating state may be estimated at a point in the future, based on measured or predicted changes in the operating state.

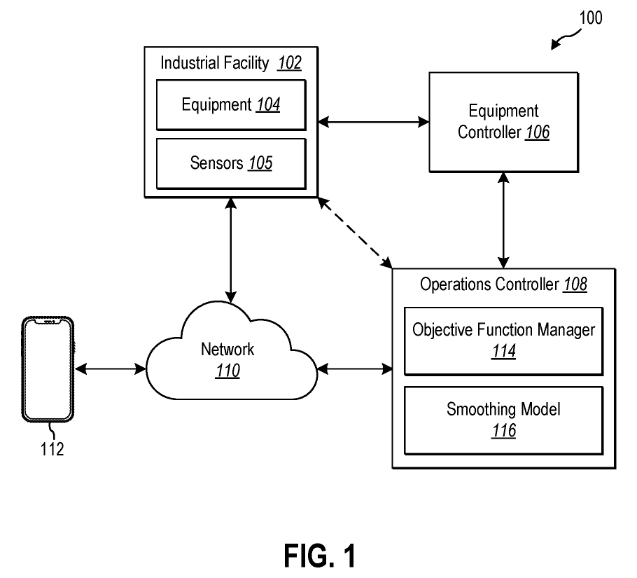

FIG. 1 is a schematic representation of an industrial process control system 100, according to at least one embodiment of the present disclosure. The industrial process control system 100 may monitor an industrial facility 102. The industrial facility 102 may include equipment 104. The equipment 104 may include any equipment that may be utilized at an industrial facility. For example, the equipment 104 may include one or more of compressors, pumps, separation units, degasification units, purification units, heat exchangers, heaters, chillers, mol sieves, dehydrators, desalters, boilers, contactors, distillation columns, membranes, filters, computer numerical control machines, any other equipment, and combinations thereof. While embodiments of the present disclosure may be related to specific types of equipment, such compressors or banks of compressors in series or in parallel, it should be understood that the techniques of the present disclosure may be applied to any unit or type of equipment.

The industrial process control system 100 may further include an equipment controller 106. The equipment controller 106 may be in communication with the equipment 104 in the industrial facility 102. For example, the equipment controller 106 may be in communication with the equipment 104 to change the operating status of the equipment 104. The equipment controller 106 may change the operating parameters of the equipment 104, such as the various settings, positioning, or other operating parameters of the equipment 104. In some examples, the equipment controller 106 may change whether a particular unit of equipment 104 is turned on or shut down. As a specific, non-limiting example, the equipment controller 106 may change the compressor settings of a compressor, such as the output pressure.

The industrial process control system 100 may include an operations controller 108. The operations controller 108 may be in communication with the industrial facility 102, including with various units of equipment 104 of the industrial facility 102, and the equipment controller 106. For example, the elements of the industrial process control system 100 may be in communication over a network 110, such as the Internet. In some embodiments, the user may communicate with elements of the industrial process control system 100 over the network 110 via a user device 112.

The operations controller 108 may receive inputs from the industrial facility 102 and/or the equipment controller 106 regarding the operating status of the equipment 104. For example, the industrial facility 102 may include one or more sensors 105. The sensors 105 may be any type of sensor used to monitor the status of the equipment 104 and/or other portions of the industrial facility 102. The operations controller 108 may receive the inputs and/or outputs of the industrial facility 102 as measured by the sensors 105. In some embodiments, the operations controller 108 may receive the inputs directly from the industrial facility 102. In some embodiments, the operations controller 108 may receive the inputs from the equipment controller 106 and/or over the network 110. The inputs received by the operations controller 108 may include any inputs. For example, the operations controller 108 may receive inputs related to a facility input to the industrial facility 102 (e.g., oil and/or gas input volume, composition, etc.). In some examples, the operations controller 108 may receive inputs related to the operating status of the equipment 104 of the industrial facility 102. In some examples, the inputs received by the operations controller 108 may include a current operating state of the industrial facility 102. In some embodiments, the operations controller 108 may generate the current operating state of the industrial facility 102 using the inputs. The operations controller 108 may include a facility model that may be used to model the current operating state.

In accordance with at least one embodiment of the present disclosure, the operations controller 108 may receive an input associated with a change in the operating state of the industrial facility 102. For example, the operations controller 108 may receive an input identifying that the facility input of an input stream of oil and/or gas has changed or will change. The operations controller 108 may include an objective function manager 114. The objective function manager 114 may include or identify an objective function associated with the industrial facility 102, or with an industrial process of the industrial facility 102. In some embodiments, the objective function may include the facility model used to model the current operating state. For example, the objective function may include some or all of the facility model, and use adjustments to the parameters of the facility model (e.g., the function parameters) to identify outputs of the industrial facility 102. In some embodiments, the objective function may be separate from the facility model. In some embodiments, the objective function may include one or more outputs from the facility model.

In some embodiments, the objective function manager 114 may include or identify multiple objective functions for the industrial facility 102. For example, the objective function manager 114 may include an objective function that is focused on portion of the industrial facility 102, a specific output of the industrial facility 102, a specific input of the industrial facility 102, or other elements of the industrial facility 102. In some embodiments, the objective function manager 114 may include a single objective function for the industrial facility 102. For example, the objective function manager 114 may include or identify multiple inputs and outputs as variables, and the objective function may be optimized for different variables.

When the operations controller 108 receives the inputs and/or outputs from the industrial facility 102, the objective function manager 114 may update the relevant objective function. For example, the objective function manager 114 may update one or more function parameters based on the current operating state of the industrial facility 102. The objective function manager 114 may further identify the outputs of the objective function manager 114, including one or more outputs for which a solution of the objective function is desired.

In accordance with at least one embodiment of the present disclosure, the objective function manager 114 may apply a smoothing model 116 to the objective function. The smoothing model 116 may smooth the objective function to improve the convergence or solution of the objective function. For example, smoothing the objective function may reduce or eliminate the skew of the objective function. Reducing or eliminating the skew of the objective function may reduce the processing resources and/or time to optimize the objective function. This may facilitate the real-time monitoring and management of the operating state of the industrial facility 102.

The objective function manager 114 may optimize the smoothed objective function. For example, the objective function manager 114 may identify, for a given output or set of outputs, the conditions that will maximize or minimize the identified output or set of outputs. In some embodiments, the objective function manager 114 may identify the operating parameters of the equipment 104 that are associated with the optimized smoothed objective function. For example, the objective function manager 114 may convert the optimized smoothed objective function (e.g., the smoothed solution) back to the un-smoothed objective function. The objective function manager 114 may identify, in the un-smoothed solution, the function parameters that result in the solution. The objective function manager 114 may determine, based on the function parameters, the operating parameters of the industrial facility 102, including equipment settings of the equipment 104, that may result in the associated function parameters. In some embodiments, the function parameters of the objective function may include the operating parameters of the equipment.

The operations controller 108 may provide the change

For example, the industrial facility 102 may provide updates or inputs to the operations controller 108 with an update frequency. The objective function manager 114 may update the objective function with the update frequency. Optimizing a smoothed objective function may facilitate real-time optimizing of the objective function. For example, the objective function may be optimized between updates. This may facilitate any changes to be identified, communicated to the equipment controller 106, and/or implemented at the equipment controller 106 in real time, or before the next update is received, or within a small amount of updates. In some embodiments real-time may include receiving the inputs from the industrial facility 102, updating the objective function at the objective function manager 114, analyzing the mapped objective function, and generating the requested output within an update time, such as 5 min, 10 min, 30 min, 1 hour, 6 hours, 12 hours, 1 day, 1 week, 1 month, or any value therebetween.

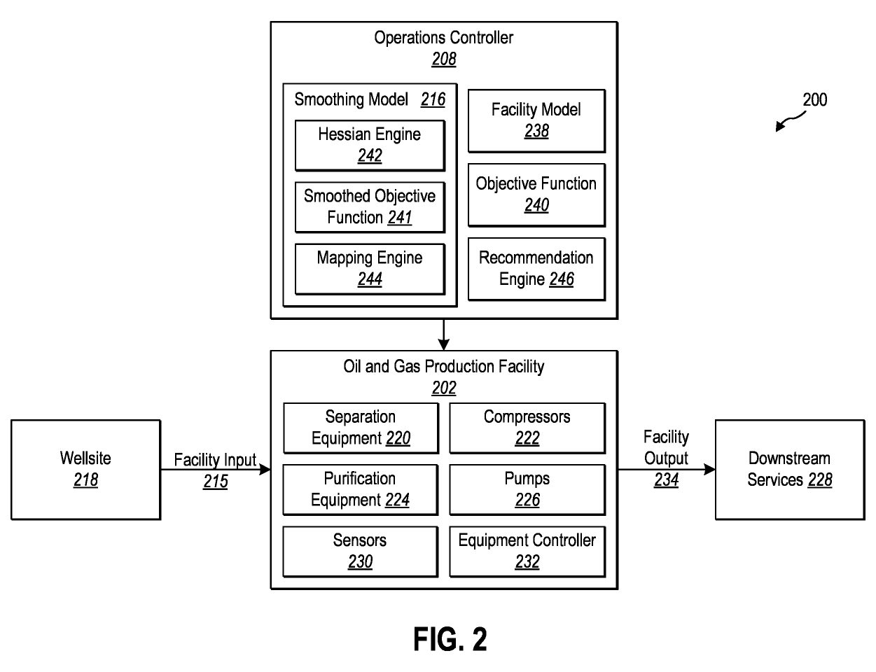

FIG. 2 is a schematic representation of an industrial facility control system 200, according to at least one embodiment of the present disclosure. In the industrial facility control system 200, an oil and gas production facility 202 (also referred to herein as a production facility 202) may receive a facility input 215 from a wellsite 218. While FIG. 2 illustrates a specific embodiment of an oil and gas production facility, it should be understood that the techniques of the present disclosure may be applied to any type of industrial facility. For example, the techniques of the present disclosure may be applied to one or more of a collection system, processing system, shipping system, manufacturing system, water processing system, chemical production system, chemical processing system, power generation system, biopharmaceutical manufacturing system, any other industrial systems, and combinations thereof.

The wellsite 218 may include one or more wells that produce a crude oil stream. In some embodiments, the facility input 215 may be acquired from a collection facility that may collect the crude oil from one or more wells that are remote from each other. The facility input 215 may include crude oil. For example, the facility input 215 may include unprocessed oil as received from the well. In some examples, the crude oil may be at least partially processed with one or more chemical additives to improve the processing and transportation of the crude oil, such as certain paraffin inhibitors, scale inhibitors, anti-agglomerant hydrate inhibitors, or other inhibitors that may facilitate the transportation of the crude oil from the well to the production facility 202. In some embodiments, the facility input 215 may include a gas input. For example, the wellsite 218 may include a natural gas well and transmit the natural gas to the production facility. In some embodiments, the facility input 215 may include a combination of oil and gas. In some embodiments, the facility input 215 may be at least partially processed. For example, the facility input 215 may be a gas stream including hydrocarbon gas that has been separated from a crude oil.

The production facility 202 may process the facility input 215 using one or more of the equipment discussed herein. It should be understood that the equipment discussed with respect to the production facility 202 are exemplary facility equipment, and that a production facility 202 may include any combination of one or more of the equipment discussed herein, with specific equipment included or excluded based on the layout of the production facility 202 and the anticipated composition of the facility input 215.

In accordance with at least one embodiment of the present disclosure, the production facility 202 may include separation equipment 220 that may separate the components of the facility input 215. For example, the separation equipment 220 may separate the oil and water phases of the facility input 215, extract gas from the facility input 215, extract solids from the facility input 215, or otherwise separate components from the facility input 215 based on the composition of the facility input 215 and the other equipment in the production facility 202. In some examples, the separation equipment 220 may separate a natural gas throughput into different gasses, such as methane, ethane, propane, and so forth.

The production facility 202 may further include one or more compressors 222. The compressors 222 may receive a gas portion of the facility input 215 and compress the gas portion for transportation, storage, or other processing. The compressors 222 may be arranged in series, with different compressors 222 increasing the pressure incrementally to a target pressure. In some embodiments, the compressors 222 may be arranged in parallel. In some embodiments, the compressors 222 may include one or more compressor sets. A compressor set may include a set of compressors 222 that are arranged in series or in parallel to process a certain throughput of gas. For example, a compressor set may include two or more compressors in series to compress the throughput of gas to the target pressure. Multiple compressor sets may be arranged in parallel to increase the total throughput of gas processed by the compressors 222. In some embodiments, the compressors 222 may include or be associated with a gas pipeline pumping station.

The production facility 202 may further include purification equipment 224. The purification equipment 224 may purify the content of the oil and/or gas in the production facility 202. For example, the purification equipment 224 may include removal systems for various gasses, such as sulfur dioxide, carbon dioxide, carbon monoxide, oxygen, nitrogen, or other gasses.

The production facility 202 may further include one or more pumps 226. The pumps 226 may pump fluid around the production facility 202 and/or out of the production facility 202 to various downstream services 228. In some embodiments, the pumps 226 may be liquid pumps configured or designed to pump liquids, including liquid oil, gas, or a combination of liquid oil and gas. In some embodiments the pumps 226 may be configured to transport gas, including blowers, fans, compressors, or other elements configured to facilitate transportation of gas in the production facility 202 and/or to the downstream services 228.

The production facility 202 may include one or more sensors 230. The sensors 230 may sense the status of the various equipment of the production facility 202, including input parameters, operating parameters, pressures, temperatures, chemical composition, flow rates, and so forth.

An equipment controller 232 may be in communication with the equipment of the production facility 202. The equipment controller 232 may make control changes to operating parameters of the equipment. For example, the equipment controller 232 may turn on equipment, turn off equipment, change motor settings, open and close valves, change temperatures, control any other aspect of the equipment, and combinations thereof.

The production facility 202 may process the facility input 215 and generate a facility output 234. The facility output 234 may be directed to the various downstream services 228. The various downstream services 228 may include any type of downstream service, such as a refinery, a power plant, directly to consumers, any other various downstream service 228, and combinations thereof.

Operation of the production facility 202 may have one or more factors or outcomes. For example, operation of the production facility 202 may result in costs, production volumes, input volumes, carbon dioxide emissions, electricity consumption, safety outcomes, maintenance actions, and so forth. As a specific, non-limiting example, the operation of the separation equipment 220, the compressors 222, the purification equipment 224, the pumps 226, and other equipment, may consume electricity. The electricity may be generated using fossil fuels or other carbon dioxide-generating methods. In some embodiments, the electricity may be grid electricity generated at a remote power generation plant. In some embodiments, the electricity may be generated using on-site generators, including diesel, gasoline, or natural gas powered generators. A flare may include point-source carbon dioxide emissions as a result of burning excess gas from the production facility 202. Further, operation of the various equipment in various operating states may cause in wear and tear on the equipment, resulting in maintenance actions, including scheduled and unscheduled maintenance. As may be understood, operation of the production facility 202 may cause a change to other factors of the production facility 202.

The operating state of the production facility 202 may be based, at least in part, on the facility input 215. For example, the operating state of the production facility 202 may be based on the volumetric or mass flow rate of the facility input 215. For example, for a facility input 215 including gas, a certain number of compressors 222 may be utilized to compress and otherwise process the input gas.

In some situations, the operating parameters of the production facility 202 may be adjustable. For example, the operating parameters of one or more components of the production facility 202 may be adjustable to impact the operation of the production facility 202, such as valve positions, motor positions, number of equipment turned on, and so forth. In some embodiments, the operating parameters of the components of the production facility 202 may vary based on production rates at the wellsite 218, purchase price of the facility input 215, consumer demand, and so forth. These changes may result in a change in the operating state of the production facility 202. For example, an increase in the flow rate of the facility input 215 may cause additional equipment to come online to accommodate the higher flow rate, such as additional compressors 222 or additional compressor sets.

In accordance with at least one embodiment of the present disclosure, the industrial facility control system 200 may include an operations controller 208. The operations controller 208 may receive or identify the operating state of the production facility 202. For example, the operations controller 208 may receive one or more measurements from the sensors 230 and use the measurements to identify the operating state of the production facility 202. In some examples, the operations controller 208 may receive an indication of the operating parameters of the equipment of the production facility 202 (such as through indirect measurements), and identify or infer an operating state of the production facility 202 using the indirect indicator.

In some examples, the operations controller 208 may include a facility model 238. The facility model 238 may receive the facility input 215 and/or equipment status measurements from the sensors 230 of one or more operating parameters of the equipment of the production facility 202. The facility model 238 may determine or generate the operating state of the production facility 202 based on the received facility input 215 and/or equipment status measurements from the sensors 230.

In some embodiments, the operations controller 208 may include an objective function 240. The objective function 240 may include a representation of the impacts that various function parameters may have on the measurable outcomes of the production facility 202. The function parameters of the objective function 240 may be representative of the various components of the production facility 202, including measurements from the sensors 230, equipment operating states of the various equipment of the production facility 202, maintenance schedules, maintenance reports, employee schedules, employee team makeup, consumable consumption, facility input 215 composition and/or amount, facility output 234 composition and/or amount, costs of various components, revenue, market factors, any other component of the production facility 202, and combinations thereof.

In some embodiments, the objective function 240 may receive one or more of the function parameters from the facility model 238. For example, the facility model 238 may generate facility model outputs associated with operation of the production facility 202 and provide the facility model outputs to the objective function 240. In some embodiments, the objective function 240 may receive the function parameters from the production facility 202. In some embodiments, the objective function 240 may receive the function parameters from any other source, such as an operator, public databases, private databases, and so forth.

The operations controller 208 may further include a smoothing model 216. The smoothing model 216 may be applied to the objective function 240 to smooth the objective function 240, resulting in a smoothed objective function 241. For example, the smoothing model 216 may be applied to the objective function 240 to reduce or eliminate the skew of the objective function 240. The operations controller 208 may optimize the smoothed objective function 241. As discussed herein, smoothing the objective function 240 may reduce the processing resources and/or time used to optimize the smoothed objective function.

The smoothing model 216 may smooth the objective function 240 in any manner. For example, the smoothing model 216 may include a Hessian engine 242. The Hessian engine 242 may at least partially smooth the objective function 240 using the Hessian of the objective function 240. In accordance with at least one embodiment of the present disclosure, smoothing the objective function 240 using the Hessian may smooth the objective function 240 independent of the values of the function parameters of the objective function 240. For example, the Hessian engine 242 may facilitate smoothing of the objective function 240 without dividing the values of the objective function 240 by themselves to scale the objective function 240 or other scaling mechanism for the objective function 240.

In some embodiments, the Hessian engine 242 may facilitate smoothing of the objective function 240 in an unbiased manner. For example, the Hessian engine 242 may smooth any type of objective function 240 for any process, without generating a bespoke solution unique to the particular variables of the particular objective function 240, facility model 238, or associated production facility 202. In some examples, the Hessian engine 242 may smooth the objective function 240 based on the impact of the function parameters of the objective function 240 on the outcomes of the objective function 240. For example, the Hessian of the objective function 240 may identify the different impacts that various function parameters of the objective function 240 have on the outcome of the objective function 240. In some examples, the Hessian (including the associated eigenvalues and eigenvectors) of the objective function 240 may be used to smooth the impact that changes to the various function parameters of the objective function 240 have on the outcome of the objective function 240.

As discussed herein, smoothing the objective function 240 may reduce the processing resources and/or time to find the solution to the objective function 240. For example, smoothing the objective function 240 may reduce or eliminate the skew of the objective function 240. This may cause changes to any of the function parameters of the smoothed objective function 241 to have the same impact on the outcome of the smoothed objective function 241. This may reduce the number of iterations used to find the convergence or solution of the smoothed objective function 241. As a specific, non-limiting example, smoothing the objective function 240 may generate a hypersphere of the objective function 240.

The smoothing model 216 may further include a mapping engine 244. The mapping engine 244 may map the objective function 240 to the smoothed objective function 241 generated by the smoothing model 216. For example, the mapping engine 244 may generate a map or calculation to convert the objective function 240 to the smoothed objective function 241. The map to convert the objective function 240 to the smoothed objective function 241 may be used in any manner. For example, the map may be used to update the smoothed objective function 241 without generating a new smoothed objective function 241. For example, the map to may be used to convert measurements or other inputs to the objective function 240 to inputs to the smoothed objective function 241. This may reduce the number of times that the smoothing model 216 may generate the smoothed objective function 241.

In some embodiments, the map may be used to convert the optimized smoothed objective function 241 to an optimized objective function 240. For example, the map may be used to generate an output that may include the unsmoothed values of the function parameters at the convergence of solution of the smoothed objective function 241, or values of the function parameters in the same format and unsmoothed values as the objective function 240.

The optimized smoothed objective function 241, unsmoothed back into the format of the objective function 240, may be used to identify one or more changes to the operating parameters of the production facility 202. For example, a recommendation engine 246 may identify one or more changes to the operating parameters of the production facility 202 based on the unsmoothed solution to the smoothed objective function 241. The recommendation engine 246 may prepare a recommendation to send to the production facility 202 regarding the changes to the operating parameters. For example, the recommendation may include changes to various settings and controllable elements of the equipment of the production facility 202. The equipment controller 232 may receive the recommendation, including the recommended changes. In some embodiments, the equipment controller 232 may implement the recommended changes. This may improve the operating efficiency of the production facility 202.

In some embodiments, the industrial facility control system 200 may form a control loop between the production facility 202 and the operations controller 208. For example, the operations controller 208 may receive and/or identify the operating status of the production facility 202. The operations controller 208 may generate or update the objective function 240, and the smoothing model 216 may generate the smoothed objective function 241 using the objective function 240. The recommendation engine 246 may generate a recommendation based on the solution to the smoothed objective function 241. The equipment controller 232 may receive the recommendation and automatically implement the recommendation to improve operation of the production facility 202.

In accordance with at least one embodiment of the present disclosure, the smoothing model 216 may generate a new smoothed objective function 241 with every update of the operating status. This may help to facilitate accurate and up-to-date monitoring and/or control of the production facility 202. In some embodiments, the smoothing model 216 may generate a new smoothed objective function 241 periodically or episodically. For example, the smoothing model 216 may generate a new smoothed objective function 241 periodically, such as every 2, 3, 4, 5, 6, 7, 8, 9, 10, 50, 100, 250, 500, or more sets of measurements or updates from the production facility 202. In some examples, the smoothing model 216 may generate a new smoothed objective function 241 episodically, such as when a particular sensed change is identified, such as a change the facility input 215, a change the facility output 234, equipment turning on or off, or other changes to the production facility 202. In some embodiments, the smoothing model 216 may generate a new smoothed objective function 241 both periodically and episodically.

In some embodiments, the smoothed objective function 241 may be updated directly based on updates from the production facility 202. For example, the operations controller 208 may receive an updated operating status from the production facility 202, and the mapping engine 244 may map the updated operating status to inputs to the smoothed objective function 241. In this manner, the industrial facility control system 200 may identify changes to the production facility 202 without generating a new smoothed objective function 241 with every update.

In accordance with at least one embodiment of the present disclosure, the objective function 240 may be optimized or optimized for different outputs or outcomes of the objective function 240. The smoothed objective function 241 may be optimized independent of the specific outcome optimized for. As a specific, non-limiting example, the objective function 240 may be optimizable for a first output or first outcome and the objective function 240 may be optimizable for a second output or a second outcome. The first output may be of a different type than the second output. As a specific, non-limiting example, the first output or outcome may be cost, and the second output or outcome may be carbon dioxide emissions. However, it should be understood that the techniques of the present disclosure may be applied to any of the outputs, outcomes, or other variables of the objective function 240 that may be maximized or minimized.

In some embodiments, the smoothing model 216 may be applied to the objective function 240 based on the first output or the second output. For example, the smoothing model 216 may be applied to the objective function 240 to increase the efficiency of the production facility 202 based on the first output or the second output. In some embodiments, the smoothed objective function 241 may be optimized for the first output and the second output. The changes used to improve the efficiency based on the first output or the second output may be compared, and the operations controller 208 may select the first solution or the second solution, based on which solution may be preferable based on business goals or other metrics.

In some embodiments, the objective function 240 may include multiple models for different industrial processes of the production facility 202. For example, a first objective function 240 may be generated for the fluid processing and a second objective function 240 may be generated for gas processing. In some embodiments, the smoothing model 216 may be agnostic to the type of objective function 240. For example, the same smoothing model 216 may be applied to the fluid processing objective function 240 as the gas processing objective function 240. As discussed herein, the smoothing model 216 may not be specific to a local solution, or may not be a bespoke or unique solution to each different industrial process. This may increase the applicability of the smoothing model 216.

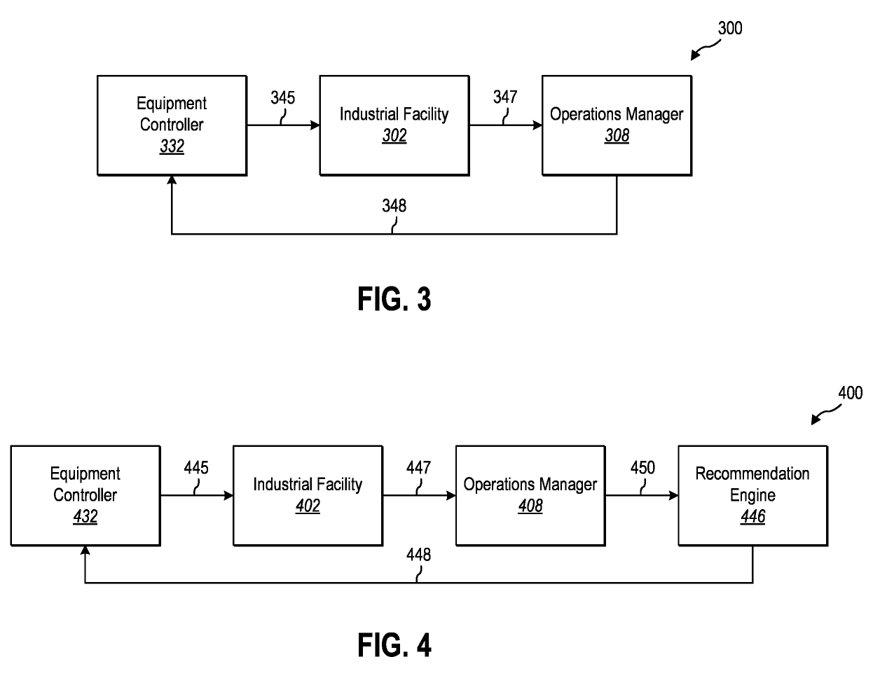

FIG. 3 is a representation of a flow diagram of an industrial facility control system 300, according to at least one embodiment of the present disclosure. An equipment controller 332 may provide control signals 345 to an industrial facility 302. The industrial facility 302 may include equipment, and the control signals 345 may cause a change in the operating parameters of the equipment.

The industrial facility 302 may have an operating state. The industrial facility 302 may provide the operating state 347 to an operations controller 308. The industrial facility 302 may provide the operating state 347 to the operations controller 308 in any manner. For example, the industrial facility 302 may provide a representation of the inputs and outputs of the industrial facility 302 to the operations controller 308. In some examples, the industrial facility 302 may provide sensor measurements of the operating status of various units of equipment in the industrial facility 302 to the operations controller 308. As discussed herein, in some embodiments, the industrial facility 302 may provide the operations controller 308 with inputs to the objective function, or values of the function parameters of the objective function.

The operations controller 308 may smooth the objective function by applying a smoothing model to the objective function. For example, the operations controller 308 may generate a smoothed objective function that may adjust the function parameters of the objective function based on the impact the function parameters have on the output or outcomes of the objective function. The smoothed objective function may be optimized to maximize or minimize a particular factor, output, or outcome of the objective function. The Using the solution to the smoothed objective function, the operations controller 308 may provide a control instruction 348 to the equipment controller 332, which may then control a change in the operating parameters of the industrial facility 302 based on the control instruction 348.

After the change in the operating parameters and transition to the transitionary operating state, the industrial facility 302 may provide a new operating state 347 to the operations controller 308, and the operations controller 308 may generate a new control instruction 348 based on the new operating state 347. In this manner, and as may be seen, the industrial facility control system 300 may result in a control loop that may cause the industrial facility 302 operate at a higher efficiency or to maximize or minimize a particular outcome of the industrial facility 302.

FIG. 4 is a representation of a flow diagram of a production facility control system 400, according to at least one embodiment of the present disclosure. An equipment controller 432 may provide control signals 445 to an industrial facility 402. The industrial facility 402 may include equipment, and the control signals 445 may cause a change in the operating parameters of the equipment. The industrial facility 402 may have an operating state. The industrial facility 402 may provide the operating state 447 to an operations manager 408. The industrial facility 402 may provide the operating state 447 to the operations manager 408 in any manner.

The operations manager 408 may generate or update a smoothed objective function associated with the operation of the industrial facility 402. For example, as discussed herein, the operations manager 408 may apply a smoothing model to an objective function to generate the smoothed objective function. The operations manager 408 may generate a solution 450 to the smoothed objective function. In some embodiments, the solution 450 may be a solution in the format of the smoothed objective function. In some embodiments, the solution 450 may be a solution in the format of the original objective function.

The operations manager 408 may provide the solution 450 to a recommendation engine 446. The recommendation engine 446 may analyze the solution 450, including the changes to the function parameters of the objective function between the originally generated objective function and the solution 450, and the recommendation engine 446 may provide a control instruction 448. The recommendation engine 446 may provide the control instruction 448 to the equipment controller 432. The equipment controller 432 may implement the control instruction 448. As may be seen, the production facility control system 400 may be looped to automatically or semi-autonomously managed to improve the efficiency of the operation of the industrial facility 402.

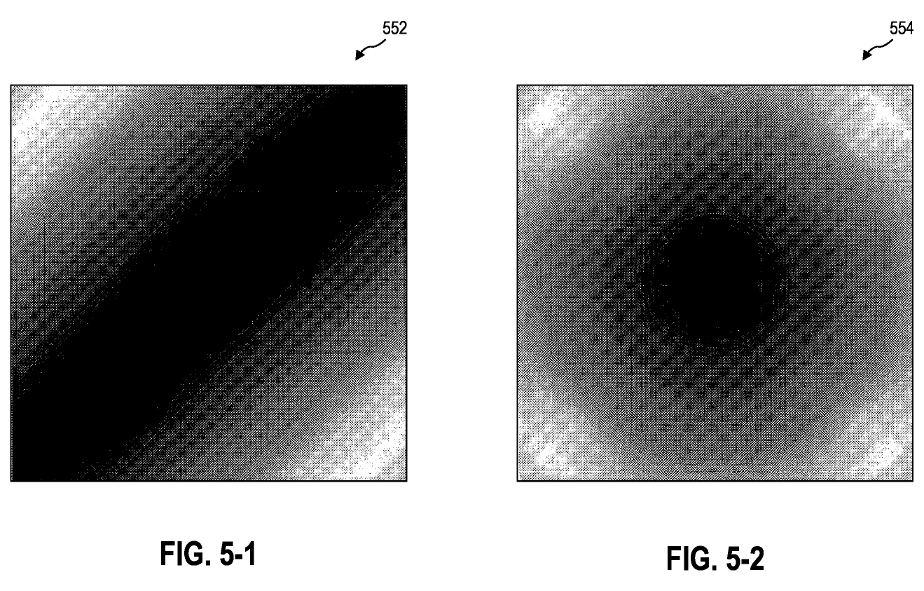

FIGS. 5-1 and 5-2 are representations of a graphical illustration of an objective function, according to at least one embodiment of the present disclosure. FIG. 5-1 is a first plot 552 of an unsmoothed objective function, or the original objective function. The iso-lines in the first plot 552 illustrate the skew of the objective function. For example, the isolines in the first plot 552 are skewed in the bottom left to top right diagonal. The center of the iso-lines is indicative of the most efficient solution to the objective function. This skew results in changes in the direction of the skew may change the outcome of the objective function to a larger degree than changes opposite the direction of the skew. Finding the most efficient solution to the objective function may involve iteratively adjusting function parameters perpendicular to the iso-lines.

FIG. 5-2 is a second plot 554 of a smoothed objective function, or the objective function of the first plot 552 that has had a smoothing algorithm applied. As may be seen, the iso-lines of the first plot 552 are circular. The circular iso-lines indicate that a change in the adjusted function parameters of the smoothed objective function will all have the same impact. When the change to the function parameters is perpendicular to the iso-lines, the operations controller may reach the solution to the smoothed objective function may be reached in fewer iterations, as perpendicular to the iso-lines may reach the center of the first plot 552 in a shorter distance.

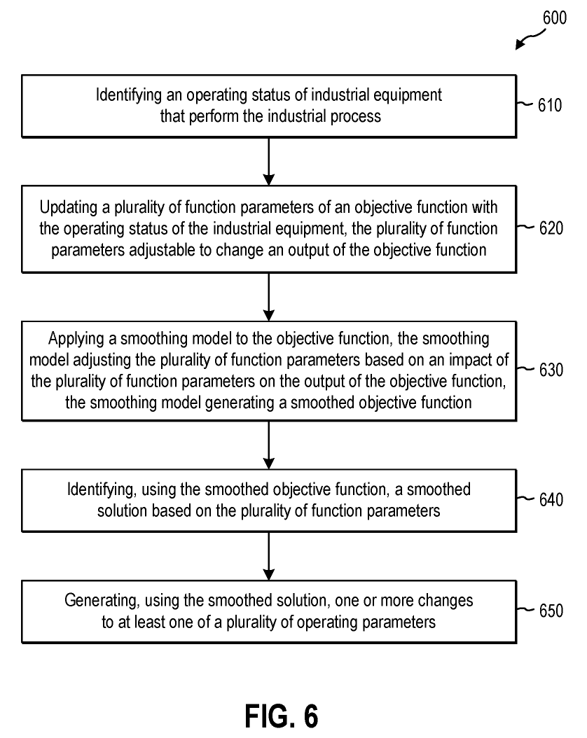

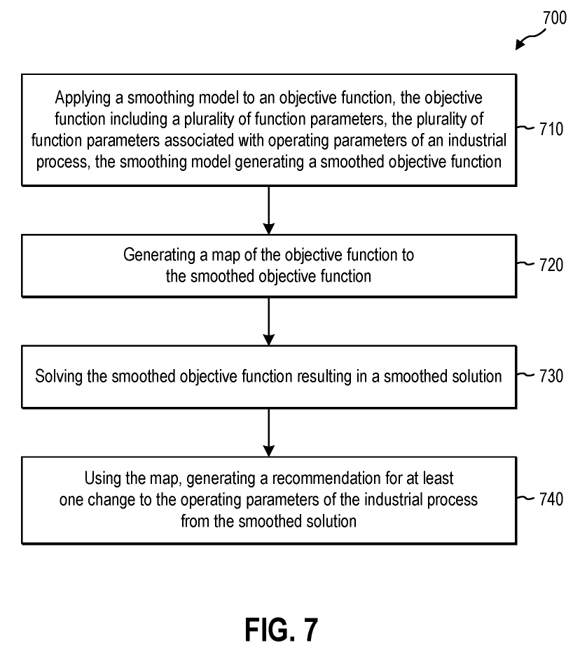

FIGS. 6 and 7, the corresponding text, and the examples provide a number of different methods, systems, devices, and computer-readable media of the industrial facility control system. In addition to the foregoing, one or more embodiments can also be described in terms of flowcharts comprising acts for accomplishing a particular result, as shown in FIGS. 6 and 7. FIGS. 6 and 7 may be performed with more or fewer acts. Further, the acts may be performed in differing orders. Additionally, the acts described herein may be repeated or performed in parallel with one another or parallel with different instances of the same or similar acts.

As mentioned, FIG. 6 illustrates a flowchart of a series of acts or a method 600 for controlling an industrial facility or an industrial process, according to at least one embodiment of the present disclosure. While FIG. 6 illustrates acts according to one embodiment, alternative embodiments may omit, add to, reorder, and/or modify any of the acts shown in FIG. 6. The acts of FIG. 6 can be performed as part of a method. Alternatively, a computer-readable medium can comprise instructions that, when executed by one or more processors, cause a computing device to perform the acts of FIG. 6. In some embodiments, a system can perform the acts of FIG. 6.

An industrial facility control system identifies an operating status of industrial equipment that perform the industrial process at 610. The industrial process control system updates a plurality of function parameters of an objective function with the operating status of the industrial equipment at 620. The plurality of function parameters are adjustable to change an output of the objective function. The industrial process control system applies a smoothing model to the objective function at 630. The smoothing model adjusting the plurality of function parameters based on an impact of the plurality of function parameters on the output of the objective function and generates a smoothed objective function. The industrial process control system identifies, using the smoothed objective function, a smoothed solution based on the plurality of function parameters at 640. The industrial process control system generates, using the smoothed solution, one or more changes to at least one of a plurality of operating parameters at 650.

In some embodiments, the changes may be generated by converting the smoothed solution to an unsmoothed solution in a form of the objective function. In some embodiments, the industrial process control system may adjust the at least one of the plurality of operating parameters based on the changes, resulting in a plurality of adjusted operating parameters. In some embodiments, the smoothing model includes a map to map the operating status to the smoothed objective function. The industrial process control system may, after adjusting the at least one of the plurality of operating parameters, identify a second operating status of the industrial equipment. Using the second operating status and the map, the industrial process control system may update the smoothed objective function to an updated smoothed objective function. The industrial process control system may further identify, using the updated smoothed objective function, an updated smoothed solution. The industrial process control system may generate, using the updated smoothed solution, one or more updated changes to at least one of the plurality of adjusted operating parameters. The industrial process control system may then adjust the at least one of the plurality of adjusted operating parameters. In some embodiments, after adjusting the at least one of the plurality of adjusted operating parameters, the industrial process control system may identify a third operating status of the industrial equipment and apply the smoothing model to the objective function with the third operating status, resulting in a new smoothed objective function.

As mentioned, FIG. 7 illustrates a flowchart of a series of acts or a method 700 for controlling an industrial facility or an industrial process, according to at least one embodiment of the present disclosure. While FIG. 7 illustrates acts according to one embodiment, alternative embodiments may omit, add to, reorder, and/or modify any of the acts shown in FIG. 7. The acts of FIG. 7 can be performed as part of a method. Alternatively, a computer-readable medium can comprise instructions that, when executed by one or more processors, cause a computing device to perform the acts of FIG. 7. In some embodiments, a system can perform the acts of FIG. 7.

An industrial process control system may apply a smoothing model to an objective function at 710. The objective function may include a plurality of function parameters that are associated with operating parameters of an industrial process. The smoothing model generates a smoothed objective function. The industrial process control system generates a map of the objective function to the smoothed objective function at 720. The industrial process control system optimizes the smoothed objective function resulting in a smoothed solution at 730. The industrial process control system, using the map, generates a recommendation for at least one change to the operating parameters of the industrial process from the smoothed solution at 740.

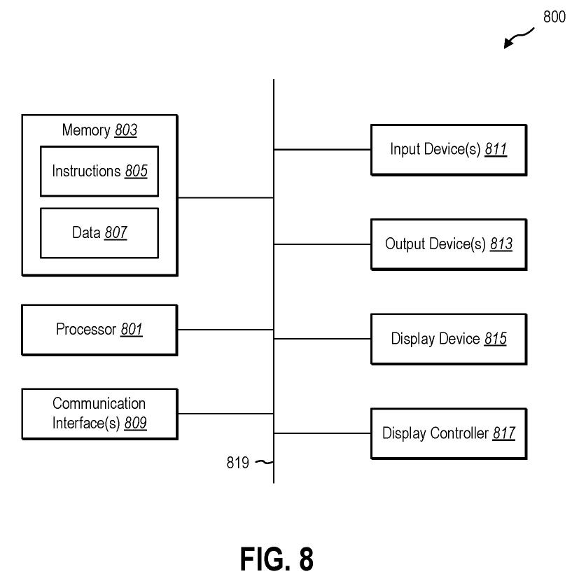

FIG. 8 illustrates certain components that may be included within a computer system 800. One or more computer systems 800 may be used to implement the various devices, components, and systems described herein.

The computer system 800 includes a processor 801. The processor 801 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during execution of the instructions 805 by the processor 801.

A computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth^{®} wireless communication adapter, and an infrared (IR) communication port.

A computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker and a printer. One specific type of output device that is typically included in a computer system 800 is a display device 815. Display devices 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers’ specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5 %, within 1 %, within 0.1 %, or within 0.01 % of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5 % of, within less than 1 % of, within less than 0.1 % of, and within less than 0.01 % of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for management of an industrial process, the method comprising:
identifying an operating status of industrial equipment that perform the industrial process;
updating a plurality of function parameters of an objective function with the operating status of the industrial equipment, the plurality of function parameters adjustable to change an output of the objective function;
applying a smoothing model to the objective function, the smoothing model adjusting the plurality of function parameters based on an impact of the plurality of function parameters on the output of the objective function, the smoothing model generating a smoothed objective function;
identifying, using the smoothed objective function, a smoothed solution based on the plurality of function parameters; and
generating, using the smoothed solution, one or more changes to at least one of a plurality of operating parameters.

2. The method of claim 1, wherein generating the one or more changes includes converting the smoothed solution to an unsmoothed solution in a form of the objective function.

3. The method of claim 1, further comprising adjusting the at least one of the plurality of operating parameters based on the one or more changes, resulting in a plurality of adjusted operating parameters.

4. The method of claim 3, wherein the smoothing model includes a map to map the operating status to the smoothed objective function, and further comprising:
after adjusting the at least one of the plurality of operating parameters, identifying a second operating status of the industrial equipment;
using the second operating status and the map, updating the smoothed objective function to an updated smoothed objective function;
identifying, using the updated smoothed objective function, an updated smoothed solution;
generating, using the updated smoothed solution, one or more updated changes to at least one of the plurality of adjusted operating parameters; and
adjusting the at least one of the plurality of adjusted operating parameters.

5. The method of claim 4, further comprising:
after adjusting the at least one of the plurality of adjusted operating parameters, identifying a third operating status of the industrial equipment; and
applying the smoothing model to the objective function with the third operating status, resulting in a new smoothed objective function.

6. The method of claim 1, wherein the impact of the plurality of function parameters is different on an outcome of the objective function.

7. The method of claim 1, wherein applying the smoothing model includes generating a Hessian of the objective function.

8. The method of claim 1, wherein the smoothing model improves a convergence of the smoothed objective function.

9. The method of claim 1, wherein the smoothed objective function includes a hypersphere.

10. The method of claim 1, wherein the smoothing model is not based on a scale of the plurality of function parameters.

11. The method of claim 1, wherein applying the smoothing model to the objective function smooths the objective function such that the impact of each of the plurality of function parameters is the same.

12. The method of claim 1, wherein the output of the objective function is a first output, and further comprising optimizing smoothed objective function for the first output and optimizing the smoothed objective function for a second output.

13. The method of claim 12, wherein the second output is a different type than the first output.

14. The method of claim 12, wherein the first output includes cost, and wherein the second output includes carbon dioxide emissions.

15. A method for management of an industrial process, the method comprising:
applying a smoothing model to an objective function, the objective function including a plurality of function parameters associated with operating parameters of an industrial process, the smoothing model generating a smoothed objective function;
generating a map of the objective function to the smoothed objective function;
optimizing the smoothed objective function resulting in a smoothed solution; and
using the map, generating a recommendation for at least one change to the operating parameters of the industrial process from the smoothed solution.

16. The method of claim 15, further comprising adjusting an operation of the industrial process based on the at least one change.

17. The method of claim 15, wherein the smoothing model smooths the objective function using an impact of the plurality of function parameters on an outcome of the objective function.

18. The method of claim 17, wherein, in the smoothed objective function, the impact of each of the plurality of function parameters is equal.

19. The method of claim 15, wherein the smoothed objective function includes a hypersphere.

20. A system, comprising:
a processor; and
memory, the memory including instructions that cause the processor to:
identify an operating status of industrial equipment that perform an industrial process;
update a plurality of function parameters of an objective function with the operating status of the industrial equipment, the plurality of function parameters adjustable to change an output of the objective function;
apply a smoothing model to the objective function, the smoothing model adjusting the plurality of function parameters based on an impact of the plurality of function parameters on the output of the objective function, the smoothing model generating a smoothed objective function;
identify, using the smoothed objective function, a smoothed solution based on the plurality of function parameters; and
generate, using the smoothed solution, one or more changes to at least one of a plurality of operating parameters.
